(19) United States
(12) Patent Application Publication
(10) Pub. No.: US 2021/0108974 A1
(43) Pub. Date: Apr. 15, 2021

(54) DEVICE FOR MEASURING A TORQUE APPLIED TO A ROTATING MEMBER

(71) Applicant: S.M.E. Società Unipersonale S.p.A., Arzignano (IT)

(72) Inventor: Adolfo PACE, Arzignano (IT)

(21) Appl. No.: 17/053,343

(22) PCT Filed: May 6, 2019
(86) PCT No.: PCT/IB2019/053668

§ 371 Date: Nov. 5, 2020

(30) Foreign Application Priority Data
May 7, 2018 (IT) 102018000005122

(51) Int. Cl. G01L 3/10; G01P 3/44; B62M 6/50

(52) U.S. Cl. CPC G01L 3/101; B62M 6/55; B62M 6/50; G01P 3/44

(57) ABSTRACT

A device for measuring a torque applied to a rotating member, comprising: a first rotating member on which a torque to measure is applied; a second rotating member; a free wheel comprising a primary ring and a secondary ring coaxial with and configurable between a coupled movement condition and a free movement condition; sensing means interposed between the first rotating member and the second rotating member and configured to detect an angular phase shift between the two rotating members. During the coupled movement condition, the free wheel is elastically deformable so that the relative position of the secondary ring is angularly shifted with respect to the position of the primary ring with an increase in the torque applied to the first rotating member and the sensing means detect the phase shift for the calculation of the applied torque.

### TECHNICAL FIELD

The present invention concerns a device for measuring a torque applied to a rotating member and a pedal-assist bicycle comprising such a device.

In particular, the invention relates to a device for measuring a torque for a bicycle, wherein sensing means are interposed between the pedal shaft and the total torque shaft.

However, the device for measuring a torque according to the present invention is applicable to any system (not only means of transport) that envisages the transmission of motion between two shafts and the measurement of torque.

### PRIOR ART

Pedal-assist bicycles, or bicycles equipped with an electric motor, are present on the market with the aim of facilitating the user during pedalling.

These pedal-assist bicycles are equipped with some electrical and electronic components which are not present on normal bicycles, for example: an electric motor, a rechargeable battery, an apparatus for sensing the torque applied by the user on the shaft of the pedal cranks and an electronic management system.

The electronic management system is able to measure and monitor the value of the applied torque and consequently manage the intervention of the electric motor to activate/deactivate or reduce its work according to needs, i.e. as a function of the effort during the pedalling phase (i.e. the torque applied to the pedal cranks by the user).

Therefore, while pedalling, the cyclist will benefit from the intervention of the electric motor which will in part replace the user, reducing their physical effort; as soon as the pedalling load is reduced, the apparatus that measures the new motor torque value sends the information to the management system which will also make the torque dispensed by the electric motor decrease. Simultaneously to the intervention of the electric motor on the bicycle transmission, the user must see to managing the transmission ratio acting on the transmission itself.

According to the prior art, an example of an apparatus for detecting the applied torque is described in documents EP0891923, US2018/118304, or in document WO2017137940 in the name of the same Applicant. In this document, the applied torque is detected thanks to sensors able to detect the angular phase shift which is established between two phonic wheels solidly constrained to two different rotating shafts, the shaft of the pedal cranks and the torque output shaft connected to the electric motor. Elastic members are interposed between the two phonic wheels, such as Belleville springs, which are opposed to the angular phase shift induced by the pedalling to return the system to the initial state, i.e. to reduce the phase shift to a minimum.

However, the prior art has a series of drawbacks which the present invention aims to overcome.

The high number of components necessary for obtaining the sensing apparatus described in the prior art consequently involves having a long and difficult assembly procedure.

Moreover, the presence of Belleville springs and of the relative support structure raises the costs of placing the apparatus on the market.

Finally, the bicycle, or more generally the transport means (or other) on which such apparatus for sensing a torque will be applied will have a weight that is not negligible.

### SUMMARY

In this context, the technical task of the present invention is to propose a device for measuring a torque applied to a rotating member which obviates the drawbacks of the known art as mentioned above.

In particular, one object of the present invention is to reduce the components necessary in order to obtain a device for measuring a torque applied to a rotating member through the angular phase shift between the shaft of the pedal cranks and the torque output shaft.

Another object of the present invention is to provide a device for measuring a torque applied to a rotating member whose assembly is simplified and therefore faster.

A further object of the present invention is to provide a device for measuring a torque applied to a rotating member with reduced costs with respect to the known art, as a consequence of the reduction in the number of components necessary for its assembly and the time required for the assembly itself.

Finally, a last object of the present invention is to provide a pedal-assist bicycle having a reduced weight with respect to the prior art, but also equipped with a device for measuring a torque applied to a rotating member.

The stated technical task and specified objects are substantially achieved by a device for measuring a torque applied to a rotating member, which comprises the technical features disclosed in the independent claim. The dependent claims correspond to further advantageous aspects of the invention.

It should be noted that this summary is provided to introduce a selection of concepts in a simplified form, which are further described below in the detailed description. This summary is not intended to be used to limit the scope of the subject matter claimed.

The invention concerns a device for measuring a torque applied to a rotating member, which comprises: a first rotating member rotating about a first rotation axis on which a torque to be measured is applied; a second rotating member rotating about a second rotation axis mechanically connected to the first rotating member; a free wheel comprising a rotating primary ring and a rotating secondary ring that is coaxial and external with respect to the primary ring, wherein the primary ring is mechanically connected to the first rotating member, while the secondary ring is mechanically connected to the second rotating member. Alternatively, the primary ring and/or the secondary ring could be realised in an integrated way respectively with the first rotating member and/or with the second rotating member so as to define a respective single body. The free wheel is also configurable between a coupled movement condition, in which the secondary ring is relatively coupled to the primary ring and the secondary ring is drawn in rotation by the primary ring and both rotate substantially at the same angular velocity, and a free movement condition, wherein the movement of the secondary ring is independent with respect to the movement of the primary ring; sensing means operatively associated with the first rotating member and with the second rotating member and configured to detect an angular phase shift between the two rotating members; Preferably, said sensing means are interposed between said first rotating member and said second rotating member.

Moreover, during the coupled movement condition, the free wheel is elastically deformable according to a direction tangential to the free wheel itself, so that the relative position of the secondary ring angularly shifts with respect to the position of the primary ring proportionally to the torque applied to the first rotating member.

In particular, during the coupled movement condition, the secondary ring and the primary ring of the free wheel are configured so as to rotate together in a same first rotation direction. While, during the free movement condition, the secondary ring is configured so as to rotate with respect to the primary ring in a same second rotation direction opposite the first direction. In other words, the free wheel is of unidirectional type.

Finally, the sensing means are configured to detect the angular phase shift between the primary ring and the secondary ring as a function of the elastic deformation of the free wheel so as to measure a value of the torque applied to the first rotating member in the coupled movement condition.

Advantageously, the placement of the free wheel between the first and second rotating member allows reducing the number of components required for the proper operation of the invention, since the free wheel itself is able to perform the function of decoupling between the first and second rotating member and the function of elastic member for the calculation of the applied torque.

According to one aspect of the invention, the device comprises a control unit electrically connected to the sensing means and configured to receive therefrom a phase shift signal representing the angular phase shift detected between the first rotating member and the second rotating member as a function of the elastic deformation of the free wheel following the torque applied to the first rotating member. Furthermore, the control unit is configured so as to generate an applied torque signal representing the torque applied as a function of the contents of the phase shift signal.

Preferably, the sensing means are configured to detect continuously in time an angular phase shift between the first rotating member and the second rotating member following a sampling frequency. Consequently, the control unit is configured to compare the phase shift signal detected for each time instant with a reference phase shift value.

A constant sampling of the phase shift advantageously allows obtaining a correct and updated measurement of the applied torque, since the control unit is able to constantly compare the detected phase shift with the reference phase shift.

Even more preferably, the control unit is configured to generate a torque signal containing a null value when the angular phase shift value detected is less than or equal to a reference phase shift value and to generate a torque signal containing a non-null value when the angular phase shift value detected is greater than the reference phase shift value. The non-null value of the torque signal is proportional to the difference between the phase shift value detected and the reference phase shift value.

According to one aspect of the invention, said sensing means are configured to detect the angular velocity of each rotating member and the reciprocal angular phase shift. The control unit is also configured to establish the reference phase shift value identical to the relative angular phase shift detected when the two velocities are equal.

Thanks to the programming of the control unit, the latter is able to constantly process the applied torque value and consequently generate a torque value appropriate to the condition in which the free wheel is located, i.e. the coupled movement or free movement condition, since it is able to constantly update the value of the reference phase shift.

According to another aspect of the invention, the sensing means comprise a first phonic wheel connected to the first rotating member, a second phonic wheel connected to the second rotating member and at least one sensor associated to each phonic wheel.

Preferably, the sensing means comprise two sensors, each associated to a respective phonic wheel and configured to generate a sinusoidal wave during the rotation of the phonic wheel. The control unit is configured so as to calculate the phase shift signal as a function of the phase shift difference between each sinusoidal wave generated by each sensor.

The sensors are able to constantly detect the rotation of the respective phonic wheel, allowing the control unit to continuously process the angular phase shift value present between the rotating members. Advantageously, this allows the control unit to process a torque signal even in a departure phase.

According to one aspect of the invention, the first phonic wheel is mechanically integral with and coaxial with the first rotating member and rotates at the same angular velocity as the latter while the second phonic wheel is mechanically integral with and coaxial with the second rotating member and rotates at the same angular velocity as the latter.

Preferably, the first phonic wheel is arranged facing the second phonic wheel. However, in other embodiments, the two phonic wheels could also not be facing, but arranged in different positions.

According to another aspect of the invention, the free wheel is operatively interposed between the first phonic wheel and the second phonic wheel.

Alternatively, the free wheel is interposed between the first rotating member and the second rotating member in a special compartment. This compartment is realised by means of a radial widening of the second rotating member with respect to the first rotating member so that a spacing adapted to contain the free wheel is defined between the rotating members.

The compartment formed thanks to the particular shape with which the second rotating member is formed, lends itself to receiving the free wheel in such a way that its primary and secondary ring are constrained, respectively, to the first rotating member and the second rotating member for a correct functioning of the free wheel itself.

According to a further aspect of the invention, the first rotating element comprises a primary shaft and the second rotating member comprises a secondary shaft coaxial to the primary shaft.

Preferably, the secondary shaft is realised in a single piece with the respective phonic wheel.

According to one aspect of the invention, the free wheel is of the type with an integrated bearing. Preferably, said integrated bearing is a ball bearing, but could alternatively be a roller or a sliding bearing or other still not expressly mentioned herein.

Advantageously, as mentioned previously, the free wheel with bearings allows performing both the blocking function between the components of the device, and performing the bearing function in order to facilitate the mutual rotation of the rotating members.

According to another aspect of the invention, the free wheel internally comprises a plurality of mobile members which, in the coupled movement condition of the free wheel, are interposed by a force coupling between the primary ring and the secondary ring.

In some alternative embodiments, the free wheel can be of another type, for example a ratchet, wherein the mobile elements are configured so as to define a mechanical fitting coupling during the coupled movement condition.

Advantageously, these mobile members allow the free wheel to uncouple the movement between the rotating members when the rotation velocity of the first is lower than that of the second.

According to a further aspect of the invention, the free wheel is mounted by interference fitting on the first rotating member and is mounted by interference fitting on the second rotating member.

Alternatively, the free wheel can be mounted on at least one of the rotating members by means of keys and Seeger rings or bonding or still other means not expressly mentioned herein. The type of fixing of the free wheel with respect to a rotating member could be different with respect to the type of mounting of the same free wheel on the other rotating member.

Advantageously, the respective rings that compose the free wheel will be solidly constrained to the respective shaft on which they are constrained, rotating synchronously with the latter thanks to the considerable friction that develops between these components.

According to one aspect of the invention, the device comprises a motor enmeshed on a gearwheel splined on the second rotating member to provide the latter with an auxiliary torque. The motor can be enmeshed directly with the gearwheel or can be enmeshed through intermediate stages.

Preferably, the motor is electrically connected to the control unit so as to generate the auxiliary torque as a function of the contents of the applied-torque signal generated by the control unit.

In addition, the present invention relates to a bicycle, in which the first rotating member is connected to a pair of pedal cranks so as to receive the torque applied by a cyclist and the second rotating member is connected to a wheel of the bicycle by means of a traction system for the transmission of the applied torque.

Finally, the present invention relates to a pedal-assist bicycle that comprises a pedal shaft and a total torque shaft operatively connected to the pedal shaft.

This pedal-assist bicycle also comprises a device described previously, interposed between the pedal shaft and the total torque shaft, wherein the first rotating member coincides with the pedal shaft and the second rotating member coincides with the total torque shaft so that via the gearwheel the motor generates an auxiliary torque on the total torque shaft as a function of the measured applied torque.

A pedal-assist bicycle comprising such a device for detecting the applied torque has the advantage of being provided with light instrumentation thanks to the reduced number of components with which it is made and can consequently be assembled in less time and at a lower cost. Moreover, thanks to the programming of the electronic components (control unit) and the choice of mechanical components, this device can detect the applied torque in a standing start condition.

### BRIEF DESCRIPTION OF THE DRAWINGS

Further characteristics and advantages of the present invention will become clearer from the indicative, and therefore non-limiting, description of a preferred but not exclusive embodiment of a device for measuring a torque applied to a rotating member, as illustrated in the attached drawings, in which:

FIG. 1 shows an axonometric view of a schematic illustration of a pedal-assist bicycle comprising the device for measuring a torque applied to a rotating member according to the present invention;

FIG. 2 shows a front view of the device for measuring a torque applied to a rotating member according to the present invention;

FIG. 3 shows a section along the D axis of the device for measuring a torque shown in FIG. 2;

FIG. 4 shows a front view of the assembled set of the first rotating member, the second rotating member, the free wheel and the sensing means;

FIG. 5 shows a section along the E axis of the set shown in FIG. 4;

FIG. 6 shows a front view of the second rotating member according to the present invention;

FIG. 7 shows a section along the E axis of the second rotating member shown in FIG. 6;

FIG. 8 shows a front view of the first rotating member according to the present invention;

FIG. 9 shows a section along the E axis of the first rotating member shown in FIG. 8;

FIGS. 10, 11 and 12 show different views of the free wheel bearing according to the present invention.

With reference to the drawings, they serve solely to illustrate embodiments of the invention with the aim of better clarifying, in combination with the description, the inventive principles at the basis of the invention.

### DETAILED DESCRIPTION

The present invention concerns a device for measuring a torque applied to a rotating member.

Any modifications or variants which, in the light of the description, are evident to the person skilled in the art, must be considered to fall within the scope of protection established by the present invention, according to considerations of technical equivalence.

With reference to the mentioned figures, reference number 50 indicates overall a device for measuring a torque applied to a rotating member for a pedal-assist bicycle 100, according to the present invention.

The other numerical references refer to technical features of the invention which, barring indications otherwise or evident structural incompatibilities, the person skilled in the art will know how to apply to all the variant embodiments described.

In particular, the device 50 for measuring the torque applied to a rotating member is preferably intended for a transmission system of a pedal-assist bicycle 100, but could also be used for measuring the torque on the rotating member, or transmission shaft, in any transmission system that envisages the measurement of the torque between two shafts (preferably coaxial, as explained below) such as, for example, electric, thermal, hydraulic, pneumatic motors, . . . .

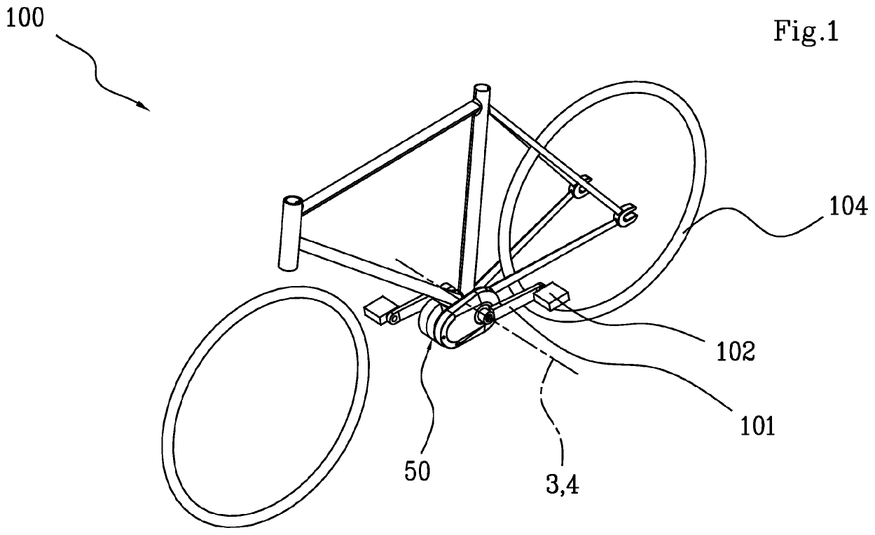

In the preferred case of the pedal-assist bicycle 100, as shown in FIG. 1, the rotating member on which a torque is applied by a user coincides with a primary shaft 14 of the device 50 on which the pedal cranks 101 are mounted (and consequently the pedals 102) of the bicycle 100 and for this reason also called pedal shaft 102.

In reference to FIG. 9, the rotating member to which the torque is applied is a first rotating member 1, which is able to rotate around a first rotation axis 3, and it also comprises the primary shaft 14.

FIG. 7 instead shows a second rotating member 2 of the device 50, the so-called total torque shaft 2, able to rotate about a second rotation axis 4, which comprises a secondary shaft 15 connected to a driving wheel 104 of the bicycle 100 (usually the rear wheel) for transmitting motion to the latter. Preferably, such transmission of the motion takes place by means of a gear change system 105 and by means of a chain.

In other words, at least one ring gear is connected (preferably splined) at a final end of the secondary shaft 15, for transmitting motion to the drive wheel 104 of the bicycle 100 (in the event of numerous ring gears, they define the gear change system 105).

According to one aspect of the invention, the secondary shaft 15 is made seamlessly in a single piece with the second rotating member 2.

In the preferred case of a pedal-assist bicycle 100, the latter comprises an assist motor M, preferably of the electric type, configured to generate an auxiliary torque and operatively connected to the secondary shaft 15 for transmitting this auxiliary torque to the secondary shaft 15 itself. Preferably, the motor M is directly enmeshed or through intermediate stages on a gearwheel 103 comprised on the secondary shaft 15 for transmitting the auxiliary torque to the latter.

In practice, the torque applied by the user is transmitted, at least in part, from the primary shaft 14 of the first rotating member 1 to the secondary shaft 15 of the second rotating member 2, which transfers it to the driving wheel 104 of the bicycle 100. In parallel, the auxiliary torque is transmitted from the motor M always towards the secondary shaft 15 as a function of the torque applied to the pedals 102.

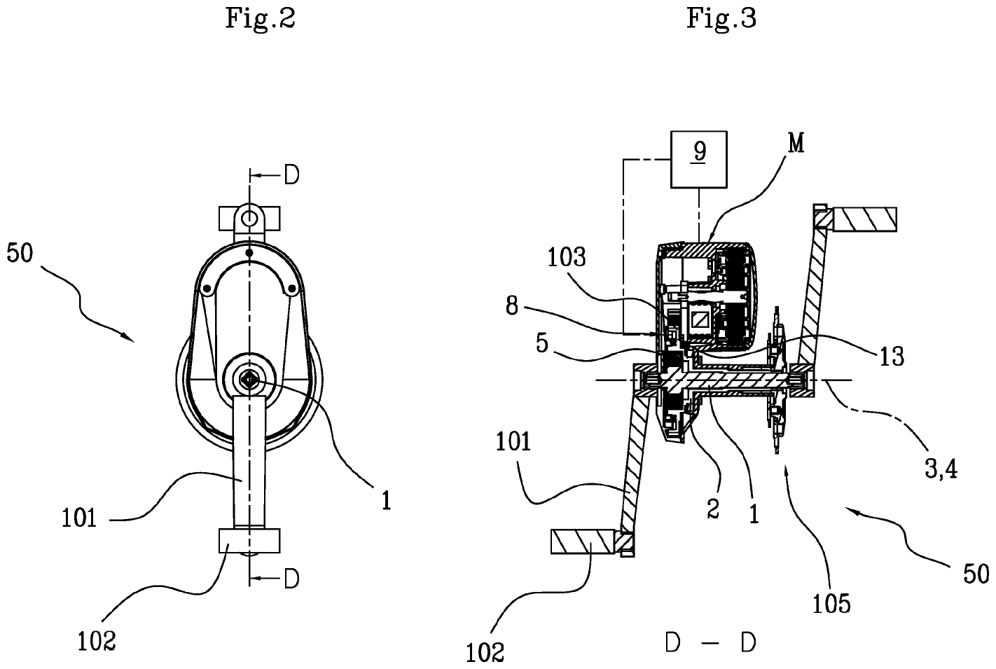

With reference to FIGS. 2 and 3, the device 50 for measuring a torque applied to a rotating member for a bicycle 100 comprises the first rotating member 1, the second rotating member 2, a free wheel 5 and sensing means 8.

Preferably, the first rotating member 1 and the second rotating member 2 are coaxial and therefore able to rotate about the same rotation axis 3, 4.

As shown in FIGS. 3 and 5, the free wheel 5 is interposed by interference fitting between the first rotating member 1 and the second rotating member 2. For better and more secure adhesion, it can be applied between the primary shaft 14 and the free wheel 5 with an adhesive sub stance.

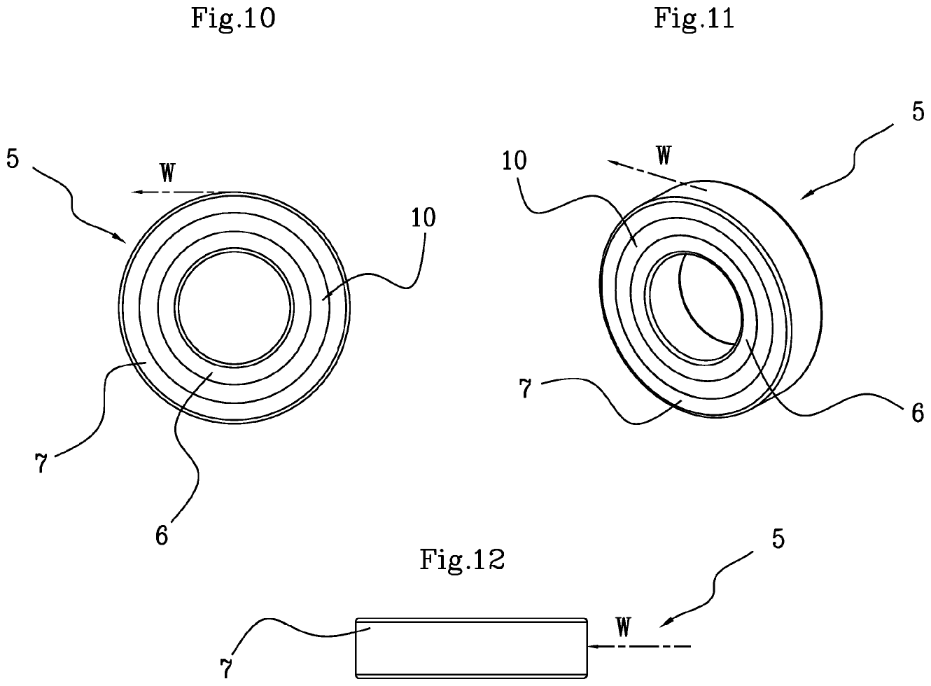

With reference to FIGS. 10, 11 and 12, the free wheel 5 comprises a primary ring 6 and a secondary ring 7, both rotating coaxially with respect to one another. Specifically, the primary ring 6 is mechanically constrained to the primary shaft 14, while the secondary ring 7 is mechanically constrained to the secondary shaft 15.

Preferably, the primary ring 6 is radially internal with respect to the secondary ring 7. In other words, the external diameter of the primary ring 6 is substantially equal to the internal diameter of the secondary ring 7. The latter, therefore, surrounds the primary ring 6.

According to a further aspect of the invention, the free wheel 5 comprises a plurality of mobile members 10 interposed by force coupling between the primary ring 6 and the secondary ring 7 to determine a coupled movement condition of the free wheel 5 itself. In the coupled movement condition, the movement of the secondary ring 7 is relatively coupled to that of the primary ring 6 so that the secondary ring 7 is drawn in rotation by the primary ring 6 and both rotate substantially at the same angular velocity.

Alternatively, the free wheel 5 can be configured in a free movement condition, wherein the movement of the secondary ring 7 is independent with respect to that of the primary ring 6.

Normally the mobile members 10 are arranged in an intermediate position and in contact between the primary ring 6 and the secondary ring 7. When the torque is applied to the primary shaft 14, the primary ring 6 starts to rotate by drawing the secondary ring 7 in the same direction of rotation, since the friction that develops between the rings 6, 7 and the mobile members 10 by force coupling is such as to make them integral with each other.

Consequently, due to the force of the friction imparted by the mobile members 10, the secondary ring 7 undergoes both a radial elastic deformation (physical expansion along its own nominal radius) and a tangential deformation, i.e. in a tangential direction T of the free wheel 5 itself, the relative position of the secondary ring 7 angularly shifts with respect to the position of the primary ring 6 with an increase in the torque applied to the first rotating member 1.

When no torque is applied to the primary shaft 14 or a torque is applied in the opposite direction with respect to the previous case, the mobile members 10 are moved to a position only in contact with the primary ring 6, allowing the secondary ring 7 to rotate in a direction opposite that of the primary ring 6.

Preferably, the free wheel 5 is of the type with a bearing. Unlike other free wheels whose components interact with each other by form coupling, i.e. by fitting between components having complementary shapes, the free wheel 5 of the present invention is capable of instantaneously switching from the coupled movement condition to the free movement condition. In fact, this free wheel 5 does not have specific fitting points in which the mobile members 10 can interact, but for their constructive characteristics, each point on the surface of the rings 6, 7 is a potential active point for the mobile members 10.

According to one aspect of the invention shown in FIG. 3, the sensing means 8, interposed between the first rotating member 1 and the second rotating member 2 are electrically connected to a control unit 9 configured to receive from them a phase shift signal representing the angular phase shift detected between the first rotating member 1 and the second rotating member 2 as a function of the elastic deformation of the free wheel 5, so as to measure the value of applied torque in the coupled movement condition.

More precisely, the sensing means 8 are configured to detect continuously in time an angular phase shift between the first rotating member 1 and the second rotating member 2 following a sampling frequency “T”.

Consequently, the control unit 9 is configured to compare the phase shift signal detected for each time instant “t” with a reference phase shift value “Dα0”.

When the angular phase shift value detected is less than or equal to the reference phase shift value “Dα0”, the control unit 9 is configured to generate a torque signal containing a null value, while when the angular phase shift value detected is greater than the reference phase shift value “Dα0” the same control unit 9 is configured to generate a non-null value torque signal proportional to the difference between the phase shift value detected and the reference phase shift value “Dα0”.

The reference phase shift value “Dα0” varies in time when the velocity of the first rotating member 1 is lower than the velocity of the second rotating member 2, therefore the sensing means 8 also detect the angular velocity of each rotating member 1, 2 and the relative angular phase shift, so that at the instant “t” in which the velocities are identical to each other, the relative angular phase shift detected is the reference phase shift value “Dα0”.

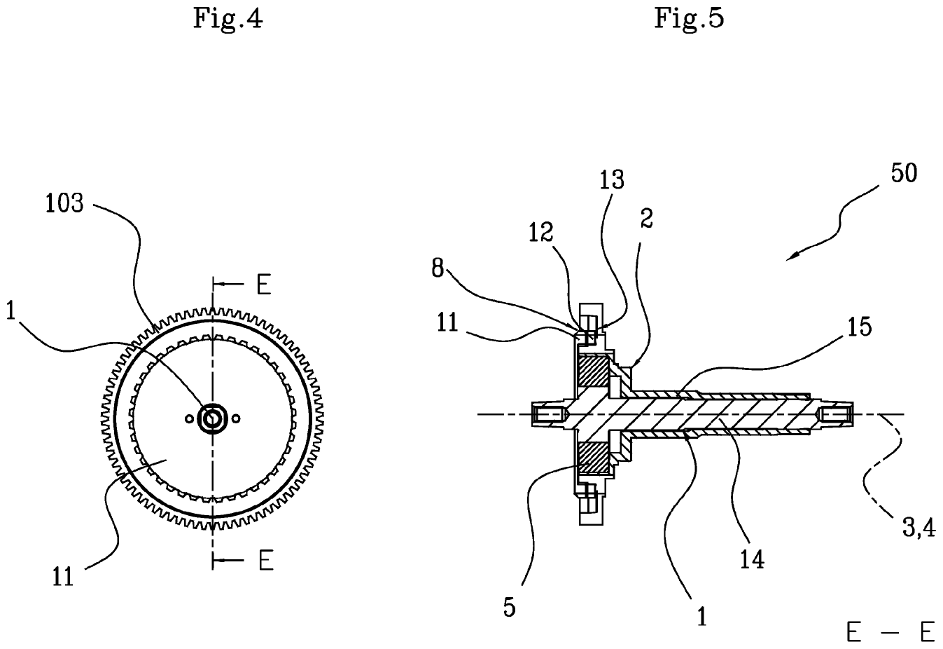

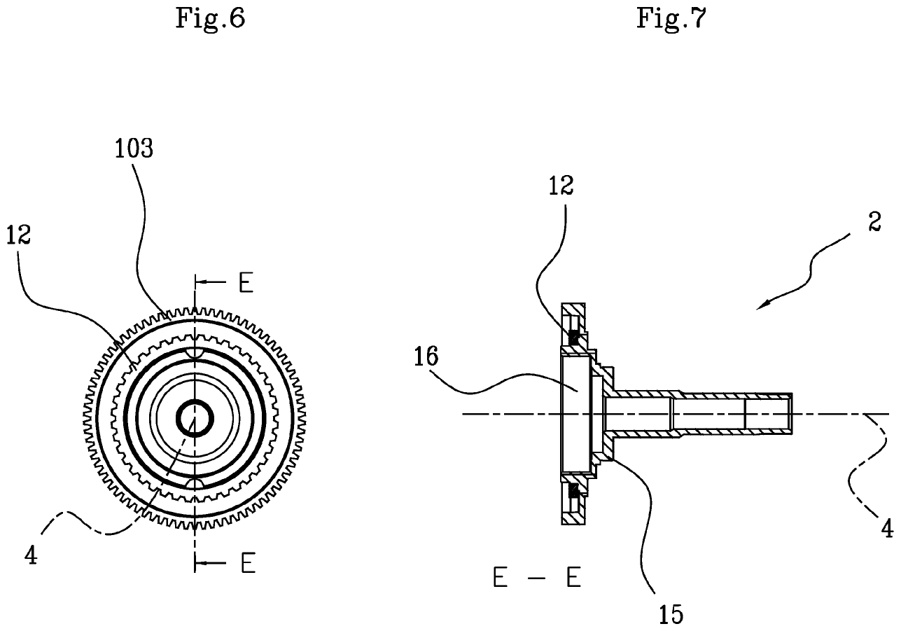

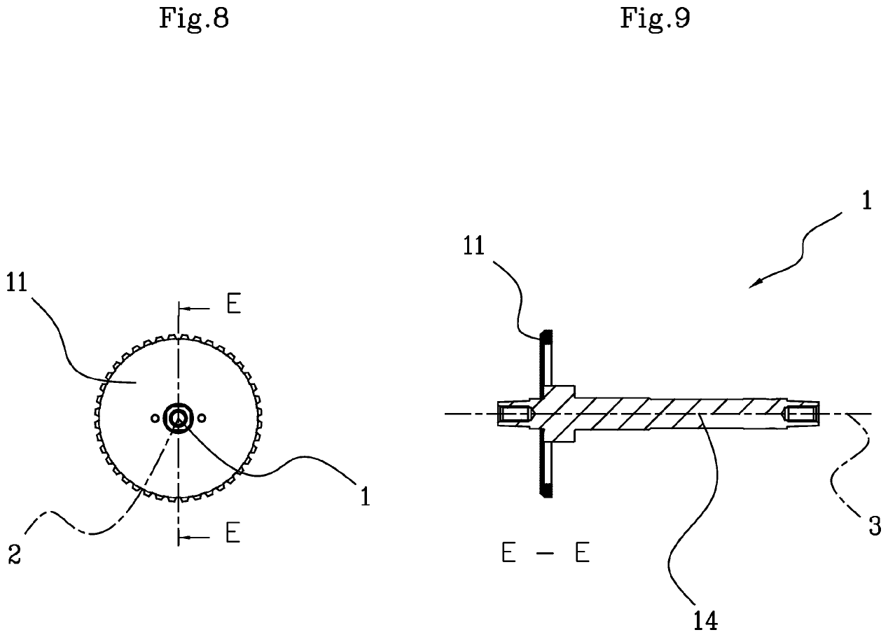

With reference to FIGS. 4 to 9, the sensing means 8 comprise a first phonic wheel 11 connected to the first rotating member 1, a second phonic wheel 12 connected to the second rotating member 2 and a sensor 13 connected to each phonic wheel 11, 12 to generate a sinusoidal wave representing the movement of the respective phonic wheel 11, 12.

According to one aspect of the invention, the free wheel 5 can be placed between the first phonic wheel 11 and the second phonic wheel 12.

However, it is preferable to arrange the free wheel 5 between the pedal shaft 1 and the total torque shaft 2, so that it can perform both the function of a common mechanical bearing, and to allow the device 50 to exploit the elasticity of the free wheel 5 itself, specifically of the secondary ring 7, in order to induce a relation between the angular phase shift between the phonic wheels 11, 12 and the applied torque.

Preferably, as can be seen in the attached figures, the two rotating members 1, 2 are mutually coaxial, and a compartment 16 is present between the two wherein the free wheel 5 is inserted. Preferably, the compartment 16 is realised through a radial widening of the second rotating member 2 with respect to the first rotating member 1 so a spacing is defined between the two.

Specifically, in FIG. 5 it can be seen that the primary ring 6 of the free wheel 5 is constrained around a specific section of the primary shaft 14, while the secondary ring 7 of the same free wheel 5 is constrained to the corresponding portion of the secondary shaft 15, which is radially widened with respect to the rest of the secondary shaft 15.

As previously anticipated, therefore, the device 50 has two possibilities for operation.

The first case envisages that the angular velocity of the pedal shaft 1 is less than that of the total torque shaft 2. In this case the free wheel bearing 5 is configured in the free movement condition and consequently no torque is exerted on the total torque shaft 2 and therefore on the drive wheel of the pedal-assist bicycle 100.

The sensors 13 which process the signal are of the analog type, for which the angular position of each phonic wheel 11, 12 referring to the respective tooth, is calculated with the following formula:

$$α ( t ) = arc tg ( \frac{{V}_{1} ( t )}{{V}_{1 , peak}} \frac{{V}_{2 , peak}}{{V}_{2} ( t )} )$$

Calculating the angular position and velocity for each of the phonic wheels 11, 12, always in reference to the respective tooth, at the instants n and n−1 sampled at period T, the angular position parameters are obtained:

$${α}_{{pedal}_{n}} ; {α}_{{torque}_{{t}_{n}}} ; {α}_{{pedal}_{n - 1}} ; {α}_{{torque}_{{t}_{n - 1}} ;}$$

and the relative velocities

$$\begin{matrix}{velocity}_{{pedal}_{n}} = \frac{( {α}_{{pedal}_{n}} - {α}_{{pedal}_{n - 1}} )}{T} ; {speed}_{{torque}_{{t}_{n}}} \\ = \frac{( {α}_{{torque}_{{t}_{n}}} - {α}_{{torque}_{{t}_{n - 1}}} )}{T}\end{matrix}$$

The velocity of the first phonic wheel 11 is less than the second phonic wheel 12, for which without any transmitted torque it has:

$${D}_{velocity} = ( {velocity}_{{pedal}_{n}} - {velocity}_{{torque}_{{t}_{n}}} ) < 0$$

Combining the equations described above, the following is obtained:

$$( \# ) {D}_{velocity} ∝ ( {α}_{{pedal}_{n}} - {α}_{{torque}_{{t}_{n}}} ) - ( {α}_{{pedal}_{n - 1}} - {α}_{{torque}_{{t}_{n - 1}}} ) \\ {D}_{velocity} {=}^{Δ} {D}_{{α}_{n}} - {D}_{{α}_{n - 1}} < 0$$

Passing, instead, to the case in which the velocity of the pedal shaft 1 reaches that of the total torque shaft 2, the torque transmitted between the primary shaft 14 and the secondary shaft 15 is greater than or equal to 0. In this case the free wheel bearing 5 is configured in the coupled movement condition, i.e. the primary ring 6 and the secondary ring 7 rotate coupled in the same direction and at the same angular velocity as they are blocked by the friction of the mobile members 10 interposed between them. Therefore, there will be the transmission of the applied torque with the consequent tangential elastic deformation of the secondary ring 7 and the consequent formation of an angular phase shift with the primary ring 6. Because of this elastic deformation which increases with the increase of applied torque, the phase shift existing between the two phonic wheels 11, 12 is greater than or equal to zero and always in the opposite direction with respect to the phase shift of the previous case.

The calculation of the reference angular phase shift is carried out when the applied torque is null and the bearing is going to transfer the torque (the instant in which the angular velocities of the shafts 14, 15 are identical). This means that the difference between the phases of the two wheels is constant and the previous relation (#) can be rewritten as:

$${α}_{p e d a {l}_{n}} - {α}_{{torque}_{{t}_{n}}} = D {α}_{0}$$

“Dα0” is the value of the reference angular phase shift which is acquired as a starting angle to determine the transfer characteristic of the pedal torque.

The calculation of the phase shift with an applied torque greater than zero is determined starting from the reference angular phase shift with the null torque calculated previously:

$${α}_{{pedal}_{n}} - {α}_{{torque}_{{t}_{n}}} = D {α}_{n} > D {α}_{0}$$

The difference will be proportional to the applied torque:

Torque∝(Dαₙ−Dα₀)

When the applied torque again returns to be null, the following will again be obtained:

Dαₙ=Dα₀

And when the pedalling ceases:

Dαₙ<Dαₙ₋₁

Upon the occurrence of a new condition for the transfer of torque, it is necessary to recalculate the new starting angle “Dα0” to transduce the torque again.

Preferably, the first phonic wheel 11 is mechanically integral with and coaxial with the first rotating member 1 to rotate at the same angular velocity as the latter and the second phonic wheel 12 is mechanically integral with and coaxial with the second rotating member 2 to rotate at the same angular velocity as the latter.

Each phonic wheel 11, 12 has alternating projections and recesses (teeth or holes) according to a predefined pitch. The rotation of each phonic wheel 11, 12, as a function of the applied torque, is detected by the respective sensor 13 configured to generate an output signal having at least one sinusoidal component during the rotation of a respective phonic wheel 11, 12 as a function of the magnetic field that the sensor 13 itself detects. Such signal has a frequency or period as a function of the pitch of the phonic wheel.

In detail, the sensor 13 is of the magnetic type, and when the respective phonic wheel 11, 12 is rotating, it generates an electric signal having a continuous component and a sinusoidal component depending on the conformation of the teeth of the phonic wheel.

Alternatively, at least one phonic wheel 11, 12 could be magnetised and therefore, in this case, the sensor 13 detects the magnetic field generated by the magnetised phonic wheel 11, 12.

In a further alternative embodiment, the sensing means 8 can be realised in other known ways and comprise, for example, an encoder for detecting the absolute position of one or both of the rotating members 1, 2.

The comparison of the sinusoidal waves results in the phase shift of the two phonic wheels 11, 12 and therefore the value of the torque applied to the pedals 102.

As can be seen in FIGS. 3, 4 and 5, the first phonic wheel 11 is arranged facing the second phonic wheel 12, having the same pitch if compared to each other and being circumferentially aligned so that the alternating sequence of teeth or holes is the same for both.

In other embodiments each phonic wheel could have a variable pitch (at least one different from at least another) along its circumference.

The control unit 9 is configured to receive the phase shift signal equal to the difference between each sinusoidal wave generated by each sensor 13 as a function of the movement of the respective phonic wheel 11, 12. Consequently, the control unit 9 is configured so as to generate an applied-torque signal representing the torque applied as a function of the contents of the phase shift signal.

According to one aspect of the invention illustrated in FIG. 3, the device 50 comprises a motor M enmeshed with a gearwheel 103 comprised on the second rotating member 2 to provide the latter with an auxiliary torque to reduce the angular phase shift between the latter and the first rotating member 1.

The motor M is electrically connected to the control unit 9 so as to generate the auxiliary torque as a function of the contents of the applied-torque signal generated by the control unit 9 itself.

Another object of the present invention is a pedal-assist bicycle 100, which comprises a pedal shaft 1, a total torque shaft 2 operatively connected to the total torque shaft 2 and a device 50 for measuring a torque applied to a rotating member. This rotating member on which the torque is applied coincides with the pedal shaft, which transfers at least part of the applied torque to the total torque shaft. In addition, a motor M is able to enmesh on the total torque shaft 2 thanks to a gearwheel 103 in such a way as to generate an auxiliary torque on said total torque shaft 2.

Finally, the pedal-assist bicycle 100 comprises a battery (preferably rechargeable) for powering the motor M and connected to the latter to bring it electrical energy.

With regard to an operating example of the device 50 for measuring the torque applied to the bicycle 100, it derives directly from what is described above, which is referred to below.

In particular, the driving wheel 104 receives the torque applied to the primary shaft 14 through the pedals 102.

Given the shape of the free wheel 5 interposed between the primary shaft 14 and the secondary shaft 15, the rotation of the first rotating member 1 is also reflected on the second rotating member 2.

The free wheel 5 undergoes a tangential elastic deformation, i.e. the secondary ring 7 does not rotate in a perfectly synchronous manner with respect to the primary ring 6 which, being integral with the primary shaft 14, directly receives the applied torque to be transferred.

This generates a phase shift between the first phonic wheel 11 integral with the primary shaft 14 and the second phonic wheel 12 integral with the secondary shaft 15, as a function of the torque applied by the cyclist.

The sensors 13 active on each phonic wheel 11, 12 generate two detection signals from which it is possible to calculate the phasing of the teeth of the wheel itself with respect to the position of the sensors 13 themselves. This phasing can be measured both when the wheels are stationary and moving.

From the difference in phasing of the teeth of the two wheels, the phase shift between the two wheels is obtained and therefore the value of the applied torque.

Advantageously, the sensors 13 chosen for the detection are of the analog type so as to allow continuous reading of the torque and also with the wheels stationary, which is very important for the delicate departure phase.

Therefore, the control unit 9 operatively connected with the sensors 13 receives the angular phase shift signal to process in the applied torque signal. As a function of this value, the control unit 9 manages the electrical motor M connected to the secondary shaft 15 thanks to a gearwheel 103 so that these provide an auxiliary torque to the second rotating member 2 to reduce the effort of the cyclist during the step of pedalling.

With said operation, the present invention attains the set objects.

Specifically, to provide a device 50 for detecting the applied torque composed of a reduced number of components with respect to the prior art and therefore at a low cost, easy to install and with a reduced weight.

### REFERENCE NUMBERS FOR THE FIGURES

1. first rotating member
2. second rotating member
3. first rotation axis
4. second rotation axis
5. free wheel
6. primary ring
7. secondary ring
8. sensing means
9. control unit
10. mobile members
11. first phonic wheel
12. second phonic wheel
13. sensors
14. primary shaft
15. secondary shaft
16. compartment
50. device for measuring the applied torque
100. bicycle
101. pedal cranks
102. pedals
103. gearwheel
104. driving wheel
105. gear change system
“M” motor

1. A device for measuring a torque applied to a rotating member, comprising:
a first rotating member rotating about a first rotation axis on which a torque to be measured is applied;
a second rotating member rotating about a second rotation axis mechanically connected to the first rotating member;
a free wheel comprising a rotating primary ring and a rotating secondary ring that is coaxial and radially external to said primary ring, wherein said primary ring is mechanically connected to or integrated with the first rotating member, while said secondary ring is mechanically connected to or integrated with the second rotating member; said free wheel being configurable between a coupled movement condition, in which the secondary ring is relatively coupled to the primary ring and the secondary ring is drawn in rotation by the primary ring and both rotate substantially at the same angular velocity, and a free movement condition, wherein the movement of the secondary ring is independent with respect to the movement of the primary ring; and
sensing means operatively associated to said first rotating member and to said second rotating member and configured to detect an angular phase shift between the two rotating members,
wherein said free wheel, during the coupled movement condition, is elastically deformable according to a direction tangential to the free wheel so that the relative position of the secondary ring angularly shifts with respect to the position of the primary ring proportionally to the torque applied to the first rotating member, said sensing means being configured to detect the angular phase shift between said primary ring and said secondary ring as a function of said elastic deformation of said free wheel so as to measure a torque value applied to the first rotating member during the coupled movement condition, and
wherein said free wheel integrates itself the function of elastic deformation during the coupled movement condition for the calculation of the applied torque by reducing the number of components required for this function.

2. The device according to claim 1, wherein, during the coupled movement condition, the secondary ring and the primary ring of the free wheel are configured so as to rotate together in a same first rotation direction, while during the free movement condition, the secondary ring is configured so as to rotate with respect to the primary ring in a same second rotation direction opposite the first direction.

3. The device according to claim 1, comprising a control unit electrically connected to said sensing means and configured to receive therefrom a phase shift signal representing the angular phase shift detected between the first rotating member and the second rotating member as a function of the elastic deformation of said free wheel following the torque applied to said first rotating member, said control unit being configured so as to generate an applied torque signal representing said torque applied as a function of the contents of said phase shift signal.

4. The device according to claim 3, wherein said sensing means are configured to detect continuously in time an angular phase shift between said first rotating member and said second rotating member following a sampling frequency; said control unit being configured so as to compare the phase shift signal detected for each time instant with a reference phase shift value.

5. The device according to claim 4, wherein said control unit is configured so as to generate a torque signal containing a null value when the angular phase shift value detected is lower than or equal to a reference phase shift value and so as to generate a torque signal containing a non-null value when the angular phase shift value detected is higher than a reference phase shift value, said non-null value of the torque signal being proportional to the difference between the phase shift value detected and the reference phase shift value.

6. The device according to claim 5, wherein said sensing means are configured to detect the angular velocity of each rotating member and the reciprocal angular phase shift, said control unit being configured so as to establish said reference phase shift value identical to said relative angular phase shift detected when the velocity of the first rotating member is lower than the velocity of the second rotating member.

7. The device according to claim 1, wherein said sensing means comprise a first phonic wheel connected to said first rotating member, a second phonic wheel connected to said second rotating member and at least one sensor associated to each phonic wheel.

8. The device according to claim 7, wherein said sensing means comprise two sensors, each associated to a respective phonic wheel and configured to generate a sinusoidal wave during the rotation of the phonic wheel, said control unit being configured so as to calculate said phase shift signal as a function of the phase shift difference between each sinusoidal wave generated by each sensor.

9. The device according to claim 7, wherein said first phonic wheel is mechanically integral with and coaxial with said first rotating member and rotates at the same angular velocity as the latter and said second phonic wheel is mechanically integral with and coaxial with said second rotating member and rotates at the same angular velocity as the latter.

10. The device according to claim 7, wherein said first phonic wheel is arranged facing said second phonic wheel, and wherein said free wheel is operatively interposed between said first phonic wheel and said second phonic wheel.

11. (canceled)

12. The device according to claim 1, wherein said free wheel is interposed between said first rotating member and said second rotating member in a special compartment, said compartment being realised by a radial widening of said second rotating member with respect to said first rotating member so that a spacing adapted to contain said free wheel is defined between said rotating members.

13. The device according to claim 1, wherein said first rotating member comprises a primary shaft and said second rotating member comprises a secondary shaft coaxial to said primary shaft.

14. The device according to claim 13, wherein said secondary shaft is realised in a single piece with the respective phonic wheel.

15. The device according to claim 1, wherein said free wheel is of a type having an integrated bearing.

16. The device according to any one preceding claim 1, wherein said free wheel internally comprises a plurality of mobile members interposed between said primary ring and said secondary ring wherein said mobile members during the coupled movement condition of the free wheel are configured so as to generate a force coupling between said primary ring and said secondary ring.

17. The device according to claim 1, wherein said free wheel internally comprises a plurality of mobile members interposed between said primary ring and said secondary ring, wherein said mobile members during the coupled movement condition of the free wheel are configured so as to generate a shape coupling or a mechanical fitting coupling between said primary ring and said secondary ring.

18. The device according to claim 1, wherein said free wheel is mounted by interference fitting on said first rotating member and is mounted by interference fitting on said second rotating member.

19. The device according to claim 1, comprising a motor, enmeshed directly or by intermediate stages, on a gearwheel splined on said second rotating member so as to provide the latter with at least an auxiliary torque, and wherein said motor is electrically connected to said control unit so as to generate the auxiliary torque as a function of the contents of the applied-torque signal generated by the control unit.

20. (canceled)

21. A bicycle, comprising:
a first rotating member rotating about a first rotation axis on which a torque to be measured is applied;
a second rotating member rotating about a second rotation axis mechanically connected to the first rotating member;
a free wheel comprising a rotating primary ring and a rotating secondary ring that is coaxial and radially external to said primary ring, wherein said primary ring is mechanically connected to or integrated with the first rotating member, while said secondary ring is mechanically connected to or integrated with the second rotating member; said free wheel being configurable between a coupled movement condition, in which the secondary ring is relatively coupled to the primary ring and the secondary ring is drawn in rotation by the primary ring and both rotate substantially at the same angular velocity, and a free movement condition, wherein the movement of the secondary ring is independent with respect to the movement of the primary ring; and
sensing means operatively associated to said first rotating member and to said second rotating member and configured to detect an angular phase shift between the two rotating members,
wherein said free wheel, during the coupled movement condition, is elastically deformable according to a direction tangential to the free wheel so that the relative position of the secondary ring angularly shifts with respect to the position of the primary ring proportionally to the torque applied to the first rotating member, said sensing means being configured to detect the angular phase shift between said primary ring and said secondary ring as a function of said elastic deformation of said free wheel so as to measure a torque value applied to the first rotating member during the coupled movement condition, and wherein said first rotating member is connected to a pair of pedal cranks so as to receive the torque applied by a cyclist and said second rotating member is connected to a wheel of the bicycle by a traction system for transmission of the applied torque.

22. A pedal-assist bicycle, comprising:
a pedal shaft;
a total torque shaft operatively connected to said pedal shaft; and
a device interposed between said pedal shaft and said total torque shaft, wherein said device comprises:
a first rotating member rotating about a first rotation axis on which a torque to be measured is applied;
a second rotating member rotating about a second rotation axis mechanically connected to the first rotating member;
a free wheel comprising a rotating primary ring and a rotating secondary ring that is coaxial and radially external to said primary ring, wherein said primary ring is mechanically connected to or integrated with the first rotating member, while said secondary ring is mechanically connected to or integrated with the second rotating member; said free wheel being configurable between a coupled movement condition, in which the secondary ring is relatively coupled to the primary ring and the secondary ring is drawn in rotation by the primary ring and both rotate substantially at the same angular velocity, and a free movement condition, wherein the movement of the secondary ring is independent with respect to the movement of the primary ring; and
sensing means operatively associated to said first rotating member and to said second rotating member and configured to detect an angular phase shift between the two rotating members,
wherein said free wheel, during the coupled movement condition, is elastically deformable according to a direction tangential to the free wheel so that the relative position of the secondary ring angularly shifts with respect to the position of the primary ring proportionally to the torque applied to the first rotating member, said sensing means being configured to detect the angular phase shift between said primary ring and said secondary ring as a function of said elastic deformation of said free wheel so as to measure a torque value applied to the first rotating member during the coupled movement condition, wherein said first rotating member coincides with said pedal shaft and said second rotating member coincides with said total torque shaft so that via a gearwheel, a motor generates an auxiliary torque on said total torque shaft as a function of the measured applied torque.
